(19) United States
(12) Patent Application Publication
(10) Pub. No.: US 2003/0035901 A1
(43) Pub. Date: Feb. 20, 2003

(54) Silicon carbide-based, porous, lightweight, heat-resistant structural material and manufacturing method therefor

(75) Inventor: Eiji Tani, Tosu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Eiji TANI, Tosu-shi (JP)

(21) Appl. No.: 09/931,092

(22) Filed: Aug. 17, 2001

(51) Int. Cl. B05D 1/18; B05D 3/02

(52) U.S. Cl. 427/431; 427/376.2

(57) ABSTRACT

The present invention provides a silicon carbide-based, porous, lightweight, heat-resistant material which can retain the shape of a porous structural body formed of, for example, corrugated cardboard and provides a manufacturing method therefor. The silicon carbide-based, porous, lightweight material is produced by a process including the steps of infiltrating a slurry composed of a resin and powdered silicon into a porous structural body having a framework formed of paper such as corrugated cardboard, wood, a woven cloth, a non-woven cloth, a plastic, or the like; carbonizing the infiltrated porous structural body at 900 to 1,350° C. in an evacuated or an inert atmosphere; and performing reaction-bonding for the obtained structural body at 1,350° C. or more in an evacuated or an inert atmosphere. By the reaction-bonding, silicon carbide having superior molten silicon wettability and open pores caused by the reaction during which the reaction volume decreases are simultaneously formed. In addition, the porous structural body thus obtained is infiltrated with molten silicon at 1,300 to 1,800° C. in an evacuated or an inert atmosphere, whereby the silicon carbide-based, porous, lightweight, heat-resistant material is formed.

### FIELD OF THE INVENTION

The present invention relates to silicon carbide-based, porous, lightweight, heat-resistant structural materials which are formed by a two-step reaction bonding method and which retain their molded shapes formed of corrugated cardboard or the like after sintering, and to manufacturing methods therefor. More particularly, the present invention relates to a silicon carbide-based, porous, lightweight, heat-resistant structural material which is suitable for use in various applications as, for example, a high-temperature structural member, a heat exchanger, a heat insulator, a high-temperature filter, and a furnace member; and to a manufacturing method therefor.

### DESCRIPTION OF THE RELATED ART

Since silicon carbide-based ceramics are lightweight and have superior heat resistance, abrasion resistance, corrosion resistance, and so on, in recent years, the ceramic has been widely used in various applications as a polishing member and a grinding stone as well as a high-temperature anticorrosion member, a heater member, an abrasion resistant member, and the like. Since the silicon carbide ceramic described above is generally formed by a sintering technique, this ceramic has been used in its dense block form, and accordingly, the silicon carbide ceramic has not be used in practice as a filter having a shape which can be changed according to function, a honeycomb-shaped lightweight porous structure, and the like.

Recently, research on the porous, lightweight, heat-resistant ceramic described above has started, and for example, a cordierite-based honeycomb-shaped ceramic having a low coefficient of thermal expansion has been formed by sintering an extruded part of the ceramic and has been used in practice as a catalyst carrier. As a carbon-based ceramic, a ceramic formed by using wood may be mentioned; however, this ceramic has inferior oxidation resistance. In addition to the ceramics described above, the following proposals have been disclosed.

(1) A sintered body having a porosity of approximately 35% is formed by mixing a powdered silicon carbide having a large particle size with powdered carbon, molding the mixture formed thereby, and infiltrating molten silicon into the molded part (Kaji, et al., Journal of the Ceramic Society of Japan published by The Ceramic Society of Japan, vol. 99, p. 63-67, 1991).

(2) A Si—Al—O—C or Si—Al—N—C ceramic retaining the shape formed of corrugated cardboard and having a low shrinkage rate is obtained by infiltrating a slurry, which contains an organic silicon polymer (polymethylsiloxane) and silicon or a powdered mixture of silicon and aluminum, into the corrugated cardboard three times, drying the corrugated cardboard after each infiltration, and firing the corrugated cardboard thus treated at 1,450° C. in an inert atmosphere or in a nitrogen atmosphere (Siber, et al., 101th Annual Meeting & Exposition of the American Ceramic Society, 1999).

However, in the method 1 described above, since compacted silicon carbide powder is used, complicated shapes cannot be easily formed, and the porosity is approximately 35% and is different from that of the structure of corrugated cardboard or the like.

In addition, in the method 2 described above, a complicated shape can be easily formed. However, since this method uses reaction-bonding of the silicon or the mixture of silicon and aluminum provided on the corrugated cardboard or the like with carbon or nitrogen, depending on the distribution state of the powdered silicon or aluminum provided on the surface of the corrugated cardboard, the thickness of the ceramic formed thereon may be nonuniform, the strength thereof may not be enough in some cases, and when a plurality of corrugated cardboard is laminated to each other, the bonding strength between the layers may not be satisfactory in some cases. In addition to these methods described above, a method may be considered in which corrugated cardboard is only carbonized and is then infiltrated with molten silicon; however, as in the first comparative example described below, the carbonized corrugated cardboard has a high shrinkage rate and is very brittle, and hence, there is a problem in that the corrugated cardboard may be damaged unless appropriately reinforced.

Through research by the inventor of the present invention on a method for manufacturing a fiber reinforced silicon carbide-based composite, it was discovered that since silicon was added from the outside by a melt infiltration method using molten silicon, the reaction volume increased, and that a matrix composed of dense, amorphous carbon formed by carbonizing a phenolic resin scarcely reacted with the molten silicon; however, it was also discovered that a matrix which was composed of remaining porous amorphous carbon and silicon carbide having superior molten silicon wettability, which was formed by reaction-bonding of powdered silicon with a phenolic resin, was easily infiltrated with molten silicon (Japanese Patent Application No. 11-201388). During the reaction-bonding mentioned above, the reaction volume decreases.

### SUMMARY OF THE INVENTION

Based on the understanding described above, the present invention was made in order to overcome the various problems in the conventional method for manufacturing a silicon carbide-based, porous, lightweight, heat-resistant structural material, and an object of the present invention is to provide a silicon carbide-based, porous, lightweight, heat-resistant structural material which can retain its molded shape and which can be easily formed into complicated shapes, and to provide a manufacturing method therefor.

Through intensive research by the inventor of the present invention on a method for manufacturing the silicon carbide-based, porous, lightweight, heat-resistant structural material, it was discovered that a silicon carbide-based, porous, lightweight, heat-resistant structural material in a complicated shape could be easily manufactured while the shape of a framework forming the porous structural body is retained, whereby the present invention was made. In the present invention, a porous structural body such as paper having a framework forming the shape of the porous structural body was infiltrated with powdered silicon and a resin; porous silicon carbide and remaining carbon portions were formed by reaction among the powdered silicon, the resin, and the carbon contained in the porous structural body; and this porous framework formed by the reaction described above was infiltrated with molten silicon; thereby forming the silicon carbide based structural material described above. During the reaction for forming the silicon carbide, the reaction volume decreases.

In accordance with one aspect of the present invention, a silicon carbide-based, porous, lightweight, heat-resistant structural material is produced by a process comprising a step of preparing one of a porous structural body containing carbon which remains after the porous structural body is fired in an evacuated or an inert atmosphere and a porous structural body which is decomposed during firing in an evacuated or an inert atmosphere, each porous structure body having a framework which retains the shape of the porous structure body after firing, a slurry containing a resin used as a carbon source and powdered silicon, and molten silicon; a step of infiltrating the slurry into the porous structural body; a step of carbonizing the porous structural body infiltrated with the slurry; a step of performing reaction-bonding of the carbonized porous structural body so as to form silicon carbide having superior molten silicon wettability and to simultaneously form open pores caused by the reaction-bonding during which the reaction volume decreases; and a subsequent step of infiltrating the molten silicon into the porous structural body.

In accordance with another aspect of the present invention, a method for manufacturing a silicon carbide-based, porous, lightweight, heat-resistant structural material comprises a step of preparing one of a porous structural body containing carbon which remains after the porous structural body is fired in an evacuated or an inert atmosphere and a porous structural body which is decomposed during firing in an evacuated or an inert atmosphere, each porous structure body having a framework which retains the shape of the porous structural body after firing, a slurry containing a resin used as a carbon source and powdered silicon, and molten silicon; a step of infiltrating the slurry into the porous structural body; a step of carbonizing the porous structural body infiltrated with the slurry at 900 to 1,350° C. in an evacuated or an inert atmosphere; a step of performing reaction-bonding of the carbonized porous structural body at 1,350° C. or more in an evacuated or an inert atmosphere so as to form silicon carbide having superior molten silicon wettability and to simultaneously form open pores caused by the reaction-bonding during which the reaction volume decreases; and a subsequent step of infiltrating molten silicon into the porous structural body at 1,300 to 1,800° C. in an evacuated or an inert atmosphere.

According to the porous structural material and the manufacturing method therefor of the present invention, a large structural body having a complicated shape can be easily formed, and machining of the porous structural body can be easily performed after the carbonization thereof is performed.

As the porous structural body having the framework for use in the method described above, a porous structural body is preferably used in which the slurry can be received and carbonized, and as a material preferably used for the porous structural body, for example, there may be mentioned paper such as corrugated cardboard or cardboard; vegetal matter, such as wood, straw, or bamboo; cloth; or woven cloth or non-woven cloth composed of carbon or silicon carbide. In addition, as a material used for the decomposable porous structural body, for example, a porous plastic in the form of a sponge or a sheet is preferably used.

In addition, in the method described above, as the resin used as the carbon source infiltrated into the framework of the porous structural body, a phenolic resin, a furan resin, or an organometallic resin such as polycarbosilane is preferably used, and in addition, cane sugar is also preferably used. These resins and the like mentioned above may be used alone or in combination. Furthermore, powdered carbon, powdered graphite, or carbon black may be added, and as an aggregate or an antioxidant, powdered silicon carbide, silicon nitride, zirconia, zircon, alumina, silica, mullite, molybdenum disilicide, boron carbide, boron, or the like may also be added.

The silicon used in the method described above may be a pure silicon metal, and in addition, a silicon alloy of magnesium, aluminum, titanium, chromium, manganese, iron, cobalt, nickel, copper, zinc, zirconium, niobium, molybdenum, tungsten, or the like, or the mixture thereof may also used.

### BRIEF DESCRIPTION OF THE DRAWINGS

FIG. 1 is a view for illustrating steps of forming a silicon carbide-based, porous, lightweight, heat-resistant structural material according to the present invention.

### DESCRIPTION OF THE PREFERRED EMBODIMENTS

Next, preferable embodiments of the present invention will be described.

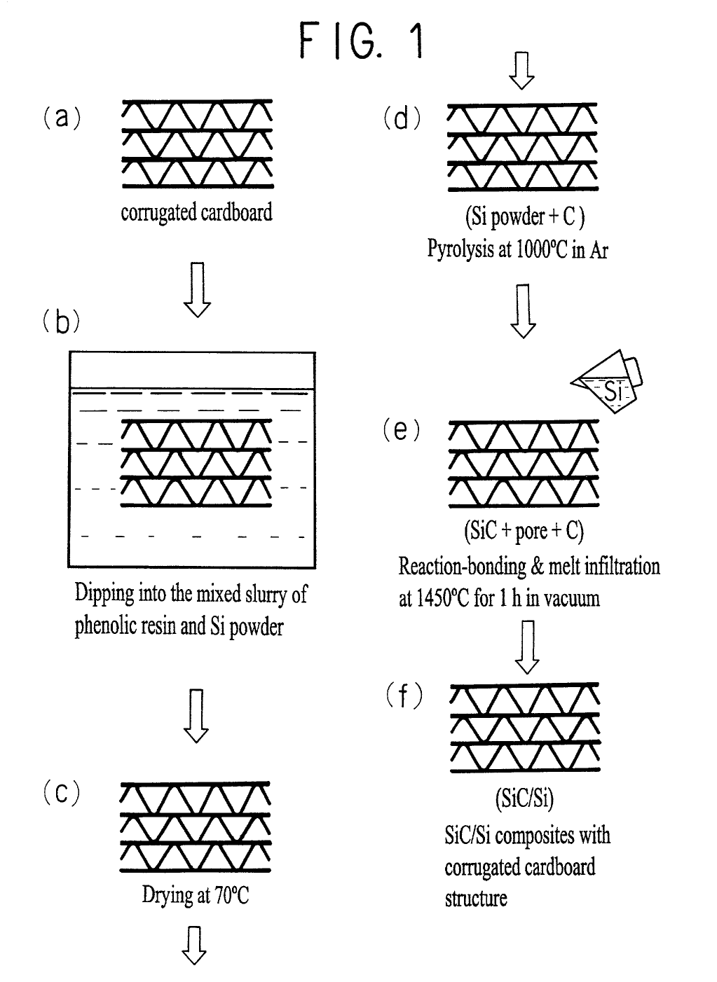

In the method of the present invention, first, a porous structural body (FIG. 1(a)) such as corrugated cardboard is coated with a slurry composed of powdered silicon and a phenolic resin or the like used as a molten carbon source or is dipped in the slurry (FIG. 1(b)), and subsequently, a porous structural body having a desired shape is formed and dried at 70° C. (FIG. 1(c)).

After the porous structural body described above is fired in an evacuated or an inert atmosphere, the carbon remains and constitutes a framework which retains the original shape of the porous structural body, and as a material for the porous structural body, paper such as corrugated cardboard or cardboard; vegetal matter, such as wood, straw, or bamboo; cloth such as woven cloth or non-woven cloth; or a porous plastic in the form of a sponge or a sheet; may be used as described above.

As the resin material infiltrated into the framework of the porous structural body, at least one selected from the group consisting of a phenolic resin, a furan resin, an organometallic polymer, and cane sugar may be used. In addition, as the powdered silicon used for forming silicon carbide, a fine powder is preferably used, and a fine powder having an average particle diameter of 20 μm or less is particularly preferable. When the powder has a large average particle diameter, it may be pulverized using a ball mill or the like so as to form a fine powder.

Next, the porous structural material thus formed is carbonized at approximately 900 to 1,350° C. in an evacuated or an inert atmosphere using an argon gas or the like. In the carbonized composite formed thereby, the framework of the porous structural body is formed of a mixture of the carbon obtained by pyrolysis of the structural body, the carbon obtained by carbonization of the phenolic resin, and the powdered silicon (FIG. 1(d)). In addition, the carbon of the phenolic resin reinforces the framework of the structural body, and hence, the carbonized porous structural body has a sufficient strength to be machined.

This carbonized porous structural body is fired at 1,350° C. or more in an inert atmosphere such as an evacuated or an argon atmosphere so that reaction occurs between the carbon and the silicon, whereby a porous silicon carbide having a superior molten silicon wettability is formed on the framework of the structural body. In addition, since the reaction volume decreases during this reaction, open pores are simultaneously formed due to the reaction mentioned above. As a result, the framework is formed of the porous silicon carbide and the remaining carbon.

Next, this porous structural body is heated to approximately 1,300 to 1,800° C. in an evacuated or inert atmosphere, and the porous silicon carbide and the carbon portions on the framework are infiltrated with molten silicon (FIG. 1(e)), thereby forming a silicon carbide-based, porous, lightweight, heat-resistant structural material (FIG. 1(f)). The reaction-bonding of the silicon and the carbon and the melt infiltration of the molten silicon may be performed in the same thermal treatment, and every thermal treatment including the carbonization may be performed in the same thermal treatment.

In the present invention, the ratio of the powdered silicon to the carbon formed of the resin is preferably determined so that Si/C is in the range of from 0.05 to 4 on an atomic basis.

Next, the present invention will be described in more detail with reference to examples; however, the present invention is not limited thereto.

### FIRST EXAMPLE

A phenolic resin and powdered silicon were prepared so that the ratio of the carbon obtained by carbonization of the phenolic resin to the silicon was 5 to 4 on an atomic basis, and ethyl alcohol was added to the phenolic resin and the powdered silicon, thereby yielding a slurry. After the slurry was processed by using a ball mill for 1 day in order to decrease the particle diameter of the silicon, corrugated cardboard was infiltrated with the slurry and was then dried.

Next, this corrugated cardboard was carbonized by firing at 1,000° C. in an argon atmosphere for 1 hour. Reaction-bonding and silicon melt infiltration were simultaneously performed for the carbonized porous body thus formed at 1,450° C. in an evacuated atmosphere for 1 hour, thereby yielding a silicon carbide-based, porous, lightweight, heat-resistant composite which retained the shape of the corrugated cardboard. The corrugated cardboard shrank during carbonization, and the size thereof was slightly smaller than the original one, such as approximately 91%, 97%, and 90% of the original size in the longitudinal, the transverse, and the thickness directions, respectively. However, the composite described above retained the molded shape of the corrugated cardboard and had a sufficient mechanical strength to be machined.

### SECOND EXAMPLE

A phenolic resin and powdered silicon were prepared so that the ratio of the carbon obtained by carbonization of the phenolic resin to the silicon was 5 to 2 on an atomic basis, and ethyl alcohol was added to the phenolic resin and the powdered silicon, thereby yielding a slurry. After the slurry was processed by using a ball mill for 1 day in order to decrease the particle diameter of the silicon, corrugated cardboard was infiltrated with the slurry and was then dried. Next, carbonization, reaction-bonding, and silicon melt infiltration were performed for this corrugated cardboard in manners equivalent to those in the first example, thereby yielding a silicon carbide-based, porous, lightweight, heat-resistant composite which retained the shape of the corrugated cardboard. The corrugated cardboard shrank during carbonization, so that the size thereof was slightly smaller than the original one, such as approximately 87%, 90%, and 88% of the original size in the longitudinal, the transverse, and the thickness directions, respectively. However, the composite described above retained the molded shape of the corrugated cardboard and had a sufficient mechanical strength to be machined.

### THIRD EXAMPLE

A mixture of a phenolic resin and powdered silicon was prepared so that the ratio of the carbon obtained by carbonization of the phenolic resin to the silicon was 5 to 2 on an atomic basis, powdered silicon carbide in the same amount as that of the silicon was added to the mixture described above, and ethyl alcohol was added to the mixture thus formed, thereby yielding a slurry. After the slurry was processed by using a ball mill for 1 day in order to decrease the particle diameter of the silicon, corrugated cardboard was infiltrated with the slurry and was then dried. Next, carbonization, reaction-bonding, and silicon melt infiltration were performed for this corrugated cardboard in manners equivalent to those in the first example, thereby yielding a silicon carbide-based, porous, lightweight, heat-resistant composite which retained the shape of the corrugated cardboard. The corrugated cardboard shrank during carbonization, so that the size thereof was slightly smaller than the original one, such as approximately 93%, 99%, and 92% of the original size in the longitudinal, the transverse, and the thickness directions, respectively. However, the composite described above retained the molded shape of the corrugated cardboard and had a sufficient mechanical strength to be machined.

### First Comparative Example

In a manner equivalent to that in the first example, corrugated cardboard was only carbonated, and subsequently, reaction-bonding and silicon melt infiltration were performed, thereby yielding a silicon carbide-based, porous, lightweight, heat-resistant composite in the form of a shrunk corrugated cardboard. The corrugated cardboard significantly shrank during carbonization, and the size thereof finally obtained was approximately 78%, 76%, and 48% of the original size in the longitudinal, the transverse, and the thickness directions, respectively. In the case in which the corrugated cardboard was only carbonized, the strength thereof after carbonization was low, and it was difficult to machine it.

### Second Comparative Example

A phenolic resin dissolved in ethyl alcohol was infiltrated into corrugated cardboard and was then dried. In manners equivalent to those in the first example, carbonization, reaction-bonding, and silicon melt infiltration were performed for this corrugated cardboard; however, the silicon melt infiltration could not be performed due to the occurrence of choking.

### Third Comparative Example

A phenolic resin and powdered silicon carbide were prepared so that the ratio of the carbon obtained by carbonization of the phenolic resin to the silicon carbide was 8 to 5 in weight ratio, and ethyl alcohol was added to the phenolic resin and the powdered silicon carbide, thereby yielding a slurry. After the slurry was processed by using a ball mill for 3 hours for mixing, corrugated cardboard was infiltrated with the slurry and was then dried. In manners equivalent to those in the first example, carbonization, reaction-bonding, and silicon melt infiltration were performed for this corrugated cardboard; however, the silicon melt infiltration could not be uniformly performed.

In the method for manufacturing the silicon carbide-based, porous, lightweight, heat-resistant composite according to the present invention, a phenolic resin and powdered silicon are applied to the framework of the porous structural body such as corrugated cardboard, the silicon carbide having superior molten silicon wettability and the open pores are formed by reaction-bonding, and silicon is infiltrated into the open pores mentioned above, whereby the silicon carbide-based, porous, lightweight, heat-resistant composite can be manufacture which retains the original shape of the porous structural body. Consequently, this composite can be easily formed into a complicated shape, and the composite described above can be used in various applications as, for example, a high-temperature structural member, a heat exchanger, a heat insulator, a high-temperature filter, and a furnace member.

What is claimed is:

1. A silicon carbide-based, porous, lightweight, heat-resistant structural material produced by a process comprising the steps of:
preparing one of a porous structural body containing carbon which remains after the porous structural body is fired in an evacuated or an inert atmosphere and a porous structural body which is decomposed during firing in an evacuated or an inert atmosphere, each porous structure body having a framework which retains the shape of the porous structure body after firing, a slurry containing a resin used as a carbon source and powdered silicon, and molten silicon;
infiltrating the slurry into the porous structural body;
carbonizing the porous structural body;
performing reaction-bonding of the porous structural body so as to form silicon carbide having superior molten silicon wettability and to simultaneously form open pores caused by the reaction-bonding during which the reaction volume decreases; and
infiltrating the molten silicon into the porous structural body.

2. A method for manufacturing a silicon carbide-based, porous, lightweight, heat-resistant structural material, comprising the steps of:
preparing one of a porous structural body containing carbon which remains after the porous structural body is fired in an evacuated or an inert atmosphere and a porous structural body which is decomposed during firing in an evacuated or an inert atmosphere, each porous structure body having a framework which retains the shape of the porous structure body after firing, a slurry containing a resin used as a carbon source and powdered silicon, and molten silicon;
a step of infiltrating the slurry into the porous structural body;
a step of carbonizing the porous structural body at 900 to 1,350° C. in an evacuated or an inert atmosphere;
a step of performing reaction-bonding of the porous structural body at 1,350° C. or more in an evacuated or an inert atmosphere so as to form silicon carbide having a superior molten silicon wettability and to simultaneously form open pores caused by the reaction-bonding during which the reaction volume decreases; and
a step of infiltrating molten silicon into the porous structural body at 1,300 to 1,800° C. in an evacuated or an inert atmosphere.

3. A method for manufacturing a silicon carbide-based, porous, lightweight, heat-resistant structural material, according to claim 2, wherein the porous structural body having the framework comprises one of paper, vegetal matter, cloth, and a porous plastic in the form of a sponge or a sheet.

4. A method for manufacturing a silicon carbide-based, porous, lightweight, heat-resistant structural material, according to one of claims 2 and 3, wherein the resin infiltrated into the porous structural body having the framework comprises at least one selected from the group consisting of a phenolic resin, a furan resin, an organometallic polymer, and cane sugar.

5. A method for manufacturing a silicon carbide-based, porous, lightweight, heat-resistant structural material, according to claim 3, wherein the paper comprises one selected from the group consisting of corrugated cardboard and cardboard, the vegetal matter comprises one selected from the group consisting of wood, straw, and bamboo, and the cloth comprises one selected from the group consisting of woven cloth and non-woven cloth.
